(19) United States
(12) Patent Application Publication
(10) Pub. No.: US 2008/0078063 A1
(43) Pub. Date: Apr. 3, 2008

(54) Spindle restricting apparatus

(75) Inventors: Jung-Wen Chang, Lu Chu Hsiang (TW); Po-Feng Chuang, Tao Yuan City (TW)

Correspondence Address: RABIN & Berdo, PC, 1101 14TH STREET, NW, SUITE 500, WASHINGTON, DC, 20005, US

(73) Assignee: Quanta Computer Inc.

(21) Appl. No.: 11/647,213

(22) Filed: Dec. 29, 2006

(30) Foreign Application Priority Data
Sep. 8, 2006 (TW) 95133348

(51) Int. Cl. E05D 3/10

(52) U.S. Cl. 16/367

(57) ABSTRACT

A spindle restricting apparatus to prevent a rotating axis and a lifting axis operating simultaneously includes a main frame, a first spindle, and a second spindle. The first spindle is disposed in a horizontal opening of the main frame and the second spindle is disposed in a vertical opening of the main frame. The first spindle has at least a first interference portion disposed on the first spindle inside of the main frame. The second spindle may have at least a second interference portion disposed on the second spindle inside of the main frame. The first interference portions would touch the second spindle to prevent the lifting axis operating while the rotating axis is operating. The second interference portions would touch the first spindle to prevent the rotating axis operating while the lifting axis is operating.

### RELATED APPLICATIONS

The present application is based on, and claims priority from, Taiwan Application Serial Number 95133348, filed Sep. 8, 2006, the disclosure of which is hereby incorporated by reference herein in its entirety.

### BACKGROUND

1. Field of Invention

The present invention relates to a spindle restricting apparatus. More particularly, the present invention relates to a spindle restricting apparatus for a convertible tablet PC (convertible tablet personal computer).

2. Description of Related Art

Recently, liquid crystal displays (LCD) have been widely applied in electrical products, due to the rapid progress of optical technology and semiconductor technology. Moreover, with the advantages of high image quality, compact size, light weight, low driving voltage, and low power consumption, LCDs have been introduced into portable computers, personal digital assistants, color televisions, and are gradually replacing the cathode ray tubes (CRT) used in conventional displays. LCDs are becoming the mainstream display apparatus.

Notebook computers are convenient to carry and therefore are often carried to business meetings. In different environments, the notebook computer has to provide different display angles to enhance demonstration capabilities thereof. However, due to a conventional restricted display angle, the notebook computer cannot provide all viewers with clear images on the display. Moreover, due to software and hardware improvements, a convertible tablet personal computer (Convertible Tablet PC) combines the notebook computer with a hand writing input device on the display. The dual-purpose convertible tablet PC provides a humanizing input interface for a user who travels. The display of a dual-purpose convertible tablet PC can rotate about 180 degrees so that viewers around the convertible tablet PC can more easily see the information and images on the display than before.

However, if the display is improperly rotated or is slid carelessly at an operating state of the convertible tablet PC, the display may collide with the keyboard and be damaged.

For the forgoing reasons, there is a need to prevent damage to the convertible tablet PC caused by rotating the display when opening the convertible tablet PC or sliding the display when rotating the display.

### SUMMARY

The present invention is directed to a spindle restricting apparatus that prevents a rotating axis and a lifting axis from operating simultaneously.

The spindle restricting apparatus includes a main frame, a first spindle, and a second spindle. The main frame includes a horizontal opening and a vertical opening. The first spindle is disposed in the horizontal opening and has at least a first interference portion. The first interference portions are disposed inside the main frame. The second spindle is disposed in the vertical opening. One of the first interference portions may touch the second spindle to prevent the lifting axis from operating when the rotating axis is operating. The second spindle includes at least a second interference portion disposed on the inside of the main frame. One of the second interference portion may touch the first spindle to prevent the rotating axis operating when the lifting axis is operating.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A to FIG. 1C illustrates a schematic diagram of an embodiment of different states of a spindle restricting apparatus of the invention;

FIG. 2 illustrates an oblique diagram of another embodiment of the spindle restricting apparatus of the invention;

FIG. 3 illustrates an exploded diagram of an embodiment of a position structure of the invention; and

FIG. 4 illustrates an exploded diagram of another embodiment of the spindle restricting apparatus of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

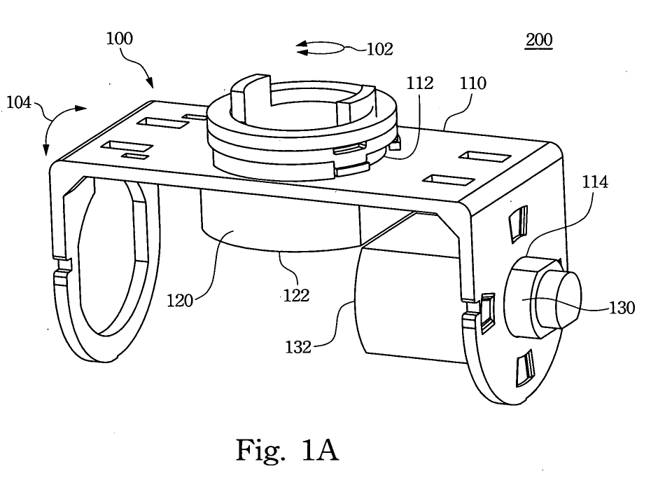

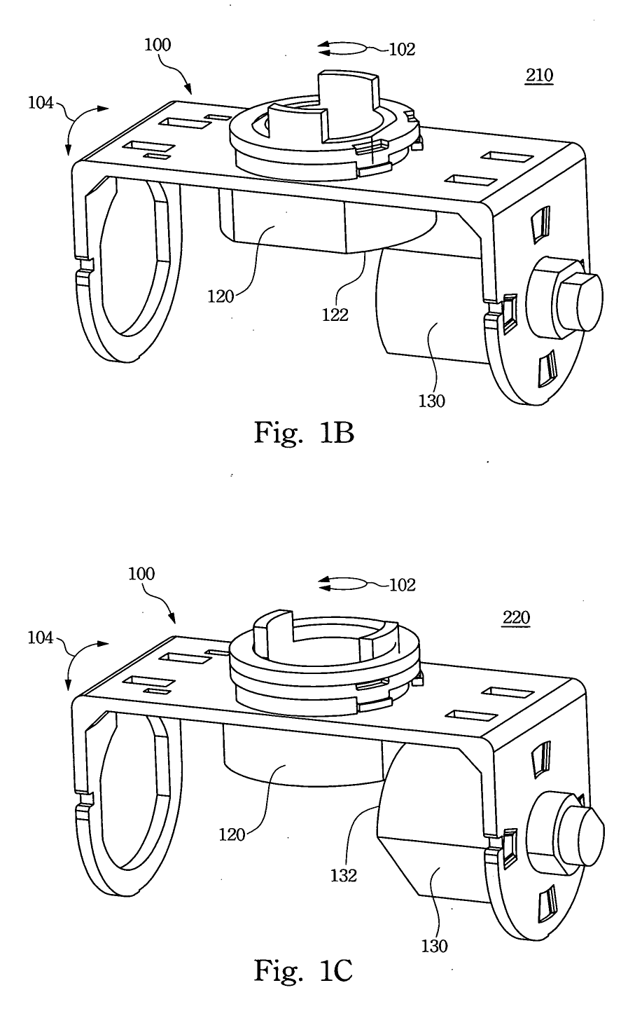

Refer to FIG. 1A to FIG. 1c. FIG. 1A to FIG. 1c illustrates a schematic diagram of an embodiment of different states of a spindle restricting apparatus. The spindle restricting apparatus 100 includes a main frame 110, a first spindle 120, and a second spindle 130. The first spindle 120 is disposed in a horizontal opening 112 of the main frame 110 and the second spindle 130 is disposed in a vertical opening 114 of the main frame 110. The spindle restricting apparatus 100 has a rotating axis 102 and a lifting axis 104. The spindle restricting apparatus 100 prevents the rotating axis 102 and the lifting axis 104 from operating simultaneously. The first spindle 120 has at least a first interference portion 122 and the first interference portion 122 is disposed inside the main frame 110. There are two first interference portions 122 in the embodiment and the first interference portions 122 are disposed on two opposite sides of the first spindle 120 inside of the main frame 110. The second spindle 130 may also have at least a second interference portion 132 and the second interference portion 132 is disposed inside the main frame 110. There are two second interference portions 132 in the embodiment and the second interference portions 132 are disposed on two opposite sides of the second spindle 130 inside the main frame 110.

Refer to FIG. 1A. The state 200 of the spindle restricting apparatus 100 is a free state. The first spindle 120 does not touch the second spindle 130 and may not be interfered with. Refer to FIG. 1B. The state 210 of the spindle restricting apparatus 100 is a rotating state. The first interference portions 122 of the first spindle 120 contact with the second spindle 130, thus the lifting axis 104 is limited and may not be operated simultaneously. Refer to FIG. 1C. The state 220 of the spindle restricting apparatus 100 is a lifting state. The second interference portions 132 touch the first spindle 120, thus the rotating axis 102 is limited and may not be operated simultaneously.

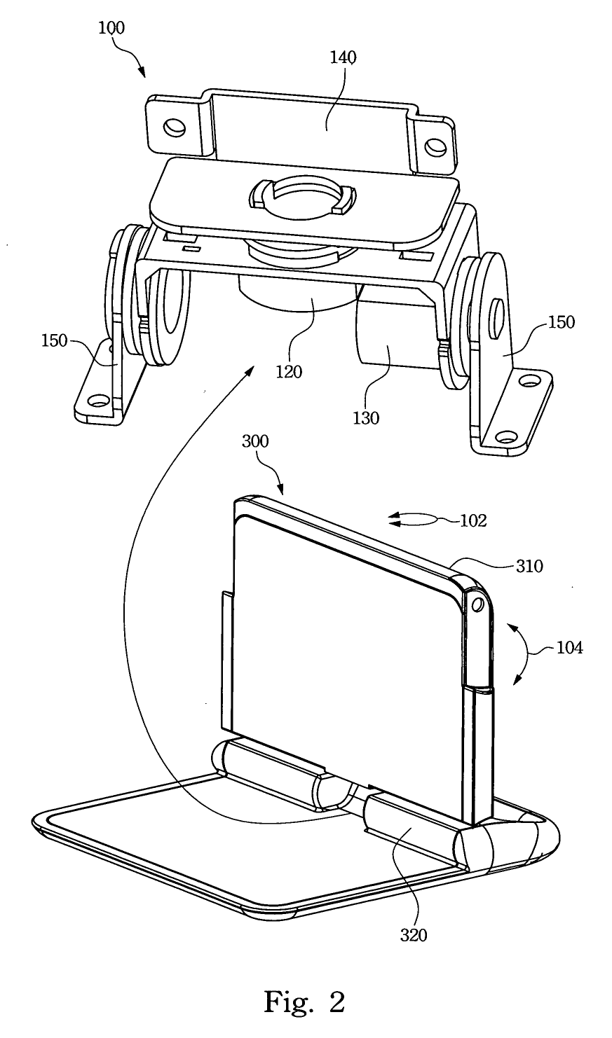

Refer to FIG. 2. FIG. 2 illustrates an oblique diagram of another embodiment of the spindle restricting apparatus 100 of the invention. The spindle restricting apparatus 100 may be assembled in a convertible tablet PC 300 to prevent the rotating axis 102 and lifting axis 104 of a display 310 of the convertible tablet PC 300 operating simultaneously and the convertible tablet PC 300 may not be damaged by the display 310 colliding with the keyboard 320. The spindle restricting apparatus 100 may have an upper frame 140 and several side frames 150. The upper frame 140 is disposed on the horizontal opening 112 of the main frame 110 and co-acts with the first spindle 120; and the side frames 150 are disposed on two opposite sides of the main frame 110. The display 310 is fixed with the upper frame 140. The side frames 150 are fixed with a keyboard 320 of the convertible tablet PC 300. The second spindle 130 may cross one of the side frames 150 and be fixed with the keyboard 320. The display 310 of the convertible tablet PC 300 may operate along the lifting axis 104 to open and position the display 310. Then the display 310 may be rotated along the rotating axis 102 to provide better display performance ability. The display 310 may be rotated clockwise or counterclockwise along the rotating axis 102. The display 310 may be rotated 180 degree and then be rotated along the lifting axis 104 to switch the convertible tablet PC 300 under another operating state. The spindle restricting apparatus 100 may further have a position structure to provide a pause signal and position the display 310 when opening the display 310 along the lifting axis 104 to be vertical to the keyboard 320 or rotate the display 310 along the rotating axis 102 180 degrees.

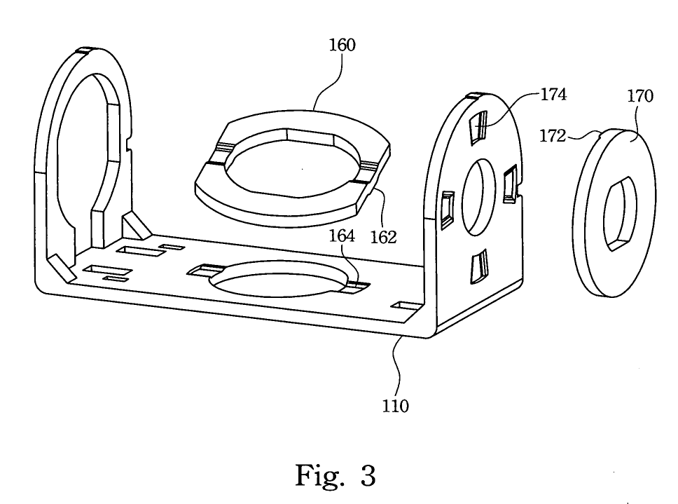

Refer to FIG. 2 and FIG. 3. FIG. 3 illustrates an exploded diagram of an embodiment of the position structure of the invention. The position structure includes a rotating position structure and a lifting position structure. The rotating position structure is a rotating position flake 160 disposed between the first spindle 120 and the main frame 110 and the rotating position flake 160 is co-acted with the first spindle 110. The rotating position flake 160 has at least a pin 162 and the main frame 110 has a plurality of rotating position cavities 164. The pin 162 may couple with at least one of the rotating position cavities 164 of the main frame 110 for positioning the display 310 along the rotating axis 102 and provides a pause signal when the first spindle 120 and the rotating position flake 160 rotate to a preset position where the pin 162 would fit into one of the rotating position cavities 164. The lifting position structure may be a lifting position flake 170 disposed between the side frame 150 and the main frame 110 and be connected with the side frame 150. The lifting position flake 170 has at least a pin 172 and the main frame 110 has a plurality of lifting position cavities 174.The pin 172 may couple with one of the lifting position cavities 174 of the main frame 110 for positioning the display 310 along the lifting axis 104 and provide the pause signal when the first spindle 120 and the main frame 110 are lifted to the preset position.

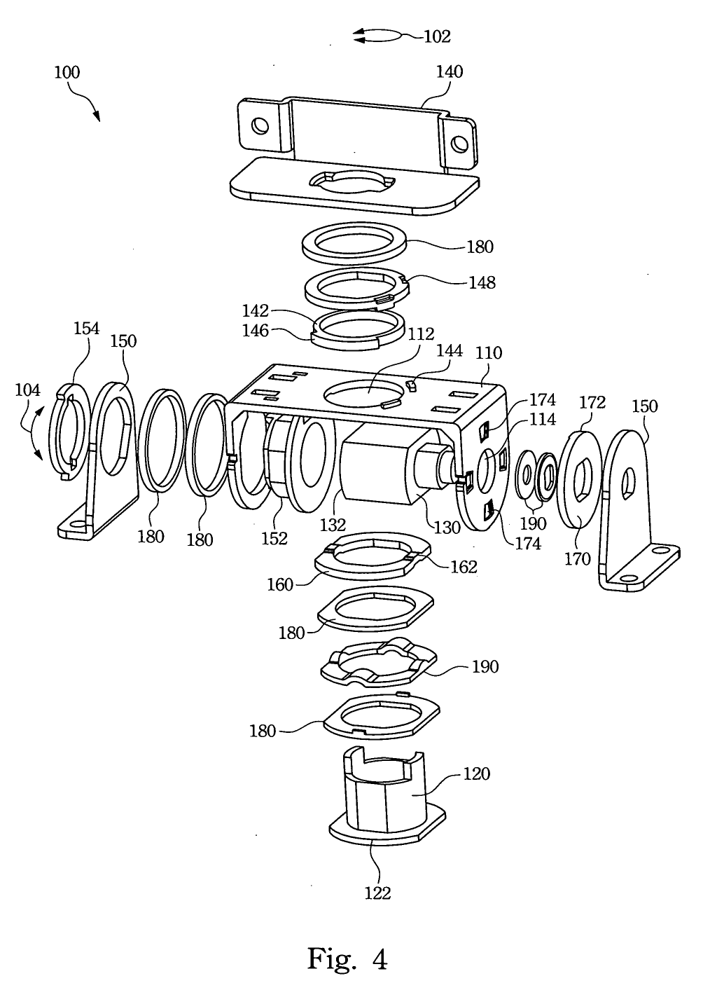

Refer to FIG. 4., FIG. 4 illustrates an exploded diagram of another embodiment of the spindle restricting apparatus of the invention. The spindle restricting apparatus 100 may further include a plurality of elastic flakes 190 to position and support the display 310. The elastic flakes 190 may be disposed between the first spindle 120 and the main frame 110 to provide a twist force to the rotating axis 102. The elastic flakes 190 may also be disposed between the side frame 150 and the main frame 110 to provide the twist force to the lifting axis 104. The spindle restricting apparatus 100 may further include a rotating stop flake 142 and a rotating control flake 148. The rotating stop flake 142 and the rotating control flake 148 are disposed between the upper frame 140 and the main frame 110. The rotating control flake 148 may drive the rotating stop flake 142 and be co-acted with the upper frame 140 and the first spindle 120. The rotating stop flake 142 has a protrusion 146 and the main frame 110 has at least a stop point 144. The protrusion 146 may be matched with the stop point 144 to stop and restrict the display 310 from over rotating. The spindle restricting apparatus 100 may further have a plurality of O-rings 180 disposed between two interaction elements to cushion the friction between the elements. The O-rings 180 may be disposed between the upper frame 140 and the main frame 110 to cushion the friction between the upper frame 140 and the main frame 110. The O-rings 180 may also be disposed between the first spindle 120 and the main frame 110 to cushion the friction between the first spindle 120 and the main frame 110. The spindle restricting apparatus 100 for the convertible tablet PC 300 may further have a third spindle 152 disposed in the vertical opening 114 of another side frame 150 without the second spindle 130. The third spindle 152 and the first spindle 120 may be a hollow spindle and several information lines may pass through. The spindle restricting apparatus 100 may further have a fixing ring 154 matched with the third spindle 152 to fix the side frame 150, the O-rings 180, and the third spindle 152 on the main frame 110. As the spindle restricting apparatus 100 in the embodiment, a shape of the elements between the main frame 110 and the first spindle 120 are designed to have the interference portion, thus the first interference portion 122 may be formed on the first spindle 120 as shown in FIG. 1A.

The spindle restricting apparatus of the embodiments may prevent the rotating axis and the lifting axis operating simultaneously by the restriction between the first spindle and the second spindle. The spindle restricting apparatus for the convertible tablet PC may prevent the rotating axis and the lifting axis between the display and the keyboard operating simultaneously and may prevent damage caused by the display colliding with the keyboard.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A spindle restricting apparatus for preventing a rotating axis and a lifting axis operating simultaneously comprising:
a main frame comprising a horizontal opening and a vertical opening;
a first spindle disposed in the horizontal opening comprising at least a first interference portion, wherein the first interference portions are disposed inside the main frame; and
a second spindle disposed in the vertical opening,
wherein one of the first interference portions touches with the second spindle to prevent the lifting axis operating when the rotating axis is operating.

2. The spindle restricting apparatus of claim 1, wherein the second spindle comprises at least a second interference portion, wherein the second interference portions are disposed inside the main frame, one of the second interference portions touches the first spindle to prevent the rotating axis operating when the lifting axis is operating.

3. The spindle restricting apparatus of claim 2, where there are two first interference portions and two second interference portions, and the first interference portions and the second interference portions are disposed on two opposite sides of the first spindle and the second spindle.

4. The spindle restricting apparatus of claim 1, wherein the spindle restricting apparatus comprises an upper frame and a side frame, wherein the upper frame is disposed on the horizontal opening of the main frame and is co-acted with the first spindle, the side frame is disposed on the vertical opening of the main frame and the second spindle is fixed on the side frame.

5. The spindle restricting apparatus of claim 4, wherein the spindle restricting apparatus comprises a rotating position structure disposed between the first spindle and the main frame; and the rotating position structure is co-acted with the first spindle.

6. The spindle restricting apparatus of claim 5, wherein the rotating position structure is a rotating position flake, the rotating position flake has at least a pin and the main frame has a plurality of rotating position cavities, wherein the pin is coupled with at least one of the rotating position cavities for positioning.

7. The spindle restricting apparatus of claim 4, wherein the spindle restricting apparatus comprises a lifting position structure disposed between the side frame and the main frame and the lifting position structure is connected with the side frame.

8. The spindle restricting apparatus of claim 7, wherein the lifting position structure is a lifting position flake, the lifting position flake has at least a pin and the main frame has a plurality of lifting position cavities, wherein the pin is coupled with at least one of the lifting position cavities for positioning.

9. The spindle restricting apparatus of claim 4, wherein the spindle restricting apparatus comprises at least an O-ring disposed between the upper frame and the main frame to cushion a friction between the upper frame and the main frame.

10. The spindle restricting apparatus of claim 4, wherein the spindle restricting apparatus comprises at least an O-ring disposed between the first spindle and the main frame to cushion a friction between the first spindle and the main frame.

11. A spindle restricting apparatus for a convertible tablet personal computer to prevent a rotating axis and a lifting axis between a display and a keyboard operating simultaneously comprising:
a main frame disposed between the display and the keyboard and connected with the display comprising a horizontal opening and a vertical opening;
a plurality of side frames having the horizontal openings disposed on two opposite sides of the main frame and fixed with the keyboard;
an upper frame disposed between the display and the main frame to connect the display and the main frame;
a first spindle disposed in the horizontal opening and co-acted with the display and the upper frame comprising at least a first interference portion, wherein the first interference portions are disposed inside the main frame; and
a second spindle disposed on one of the side frames and crossing one of the vertical openings,
wherein one of the first interference portions touches the second spindle to prevent the lifting axis operating when the display is operated along the rotating axis.

12. The spindle restricting apparatus for a convertible tablet personal computer of claim 11, wherein the second spindle comprises at least a second interference portion, wherein the second interference portions are disposed inside the main frame, one of the second interference portions touches the first spindle to prevent the rotating axis operating when the display is operated along the lifting axis.

13. The spindle restricting apparatus for a convertible tablet personal computer of claim 12, wherein there are two first interference portions and two second interference portions, and the first interference portions and the second interference portions are disposed on two opposite sides of the first spindle and the second spindle.

14. The spindle restricting apparatus for a convertible tablet personal computer of claim 11, wherein the spindle restricting apparatus for the convertible tablet personal computer comprises a lifting position structure disposed between the side frame and the main frame and the lifting position structure is connected with the side frame to position the display along the lifting axis.

15. The spindle restricting apparatus for a convertible tablet personal computer of claim 14, wherein the lifting position structure is a lifting position flake, the lifting position flake has at least a pin and the main frame has a plurality of lifting position cavities, wherein the pin is coupled with at least one of the lifting position cavities for positioning the display.

16. The spindle restricting apparatus for a convertible tablet personal computer of claim 11, wherein the spindle restricting apparatus for the convertible tablet personal computer comprises a rotating position structure disposed between the first spindle and the main frame; and the rotating position structure is co-acted with the first spindle to position the display along the rotating axis.

17. The spindle restricting apparatus for a convertible tablet personal computer of claim 16, wherein the rotating position structure is a rotating position flake, the rotating position flake has at least a pin and the main frame has a plurality of rotating position cavities, wherein the pin is coupled with at least one of the rotating position cavities for positioning the display at the rotating axis.

18. The spindle restricting apparatus for a convertible tablet personal computer of claim 11, wherein the spindle restricting apparatus for the convertible tablet personal computer comprises a plurality of O-rings disposed between the upper frame and the main frame to cushion a friction between the upper frame and the main frame and between the upper frame and the main frame to cushion a friction between the upper frame and the main frame.

19. The spindle restricting apparatus for a convertible tablet personal computer of claim 11, wherein the spindle restricting apparatus for the convertible tablet personal computer comprises a plurality of elastic flakes disposed between the first spindle and the main frame to provide a twist force to the rotating axis; and the elastic flakes are disposed between the side frame and the main frame to provide the twist force to the lifting axis.

20. The spindle restricting apparatus for a convertible tablet personal computer of claim 11, wherein the display is rotated along the rotating axis counter clockwise or clockwise.
